(19) United States
(12) Patent Application Publication
(10) Pub. No.: US 2007/0008176 A1
(43) Pub. Date: Jan. 11, 2007

(54) Traffic light status remote sensor system

(76) Inventors: J. Marcos Sirota, Takoma Park, MD (US); Antonios Seas, Ellicott City, MD (US); David Mostofi, Chevy Chase, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/151,377

(22) Filed: Jun. 13, 2005

(51) Int. Cl. G08G 1/095

(52) U.S. Cl. 340/907

(57) ABSTRACT

A Traffic-Light Status Remote Sensor System is disclosed. The basic system consists of a set of lenses, detectors, and narrowband filters. The sensor system is capable of determining the status of a traffic light (red, amber, or green) from a distance, without any connection to the electronic boards controlling the traffic light. A portable red-light photo-enforcement system working independently from the traffic light controllers is a potential application of the remote traffic light sensor.

### BACKGROUND OF THE INVENTION

1. Field of the Invention

This invention relates to a system and method for automatically determining the status of a traffic control signal and more particularly the invention relates to a system for monitoring and recording the status of a traffic signal by observing the light emitted from one or more traffic lights and using the resultant information as input to a traffic monitoring system in a controlled intersection.

2. Background of the Invention

Installing a red light photo-enforcement system in an intersection involves digging the road and pavement in order to install cables for interfacing the violation detecting/recording system with the traffic light controller for synchronization. This requirement makes the red light photo-enforcement system a permanent installation for a specific approach at an intersection. The disclosed invention eliminates the need for a cable connection between a light controller and a photo-enforcement system in order to communicate the status of the traffic signal. The state of the traffic signal can be determined remotely by using an optical system coupled to individual detectors or a CCD (charge-coupled device) image recorder as a remote traffic light sensor.

### SUMMARY OF THE INVENTION

The disclosed system eliminates the installation costs associated with interfacing the traffic signal controller with Red Light Camera applications. In conjunction with non-intrusive speed estimation technologies (such as laser or video speed sensors), the remote sensor system makes possible the development of a fully transportable photo-enforcement system. This is a significant development for smaller municipalities and police departments who cannot afford to install photo-enforcement systems in many intersections.

Implementing a removable photo-enforcement system helps improve the efficiency of documenting red light violators. Another advantage of the disclosed remote system working in combination with a red-light photo-enforcement system is that the decision making process is based on exactly what a driver sees upon entering an intersection. If, for any reason, a traffic light is broken or hidden, and the driver cannot determine the state of the traffic light, neither will the sensor. In addition, immediate information about a light malfunction may be communicated to a control office, enabling immediate action to fix the light and/or dispatch personnel, thus increasing the safety of the intersection.

Another advantage of a transportable photo-enforcement red light system is the element of surprise to red light violators. In other words, when drivers realize that an intersection has been instrumented they tend to stop violating and the municipalities may lose money.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 illustrates a geometrical arrangement of a remote traffic light sensor according to a first embodiment of the present invention.

FIG. 2 illustrates a photo-enforcement system employing the remote traffic light sensor system according to an embodiment of the present invention.

FIG. 3 shows a detector and filter arrangement according to a first embodiment of the present invention.

FIG. 4 shows detector and filter arrangements according to some alternate embodiments of the present invention.

FIG. 5 shows a detector arrangement for a multi element position sensitive detector according to an embodiment of the present invention.

FIG. 6 shows an alternate detector and filter arrangement according to another embodiment of the present invention.

FIG. 7 is a flowchart for an Installation/Calibration Algorithm of a remote traffic light status sensor system according to a first embodiment of the present invention.

FIG. 8 is a flowchart for an Operation Algorithm of a remote traffic light status sensor system according to a first embodiment of the present invention.

### DETAILED DESCRIPTION

The invention summarized above and defined by the enumerated claims may be better understood by referring to the following description, which should be read in conjunction with the accompanying drawings. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

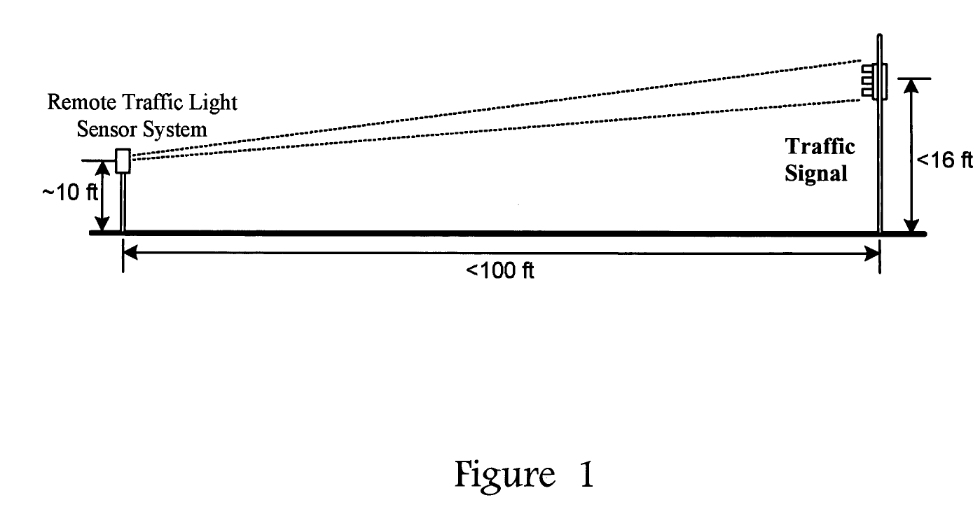

Referring now to the figures, the basic principle of operation of the disclosed sensor system is illustrated in FIG. 1, which shows the geometrical design of a remote traffic light sensor system. The traffic signal is usually installed at a sufficient height to enable tall vehicles, such as large trailer trucks to pass thereunder. The sensor should be installed at a sufficient height to avoid tampering and prevent blockage by vehicles, other structures, and vegetation. The distance between the remote sensor and traffic signal should be determined based upon a sufficient field of view of the lights of the traffic signal.

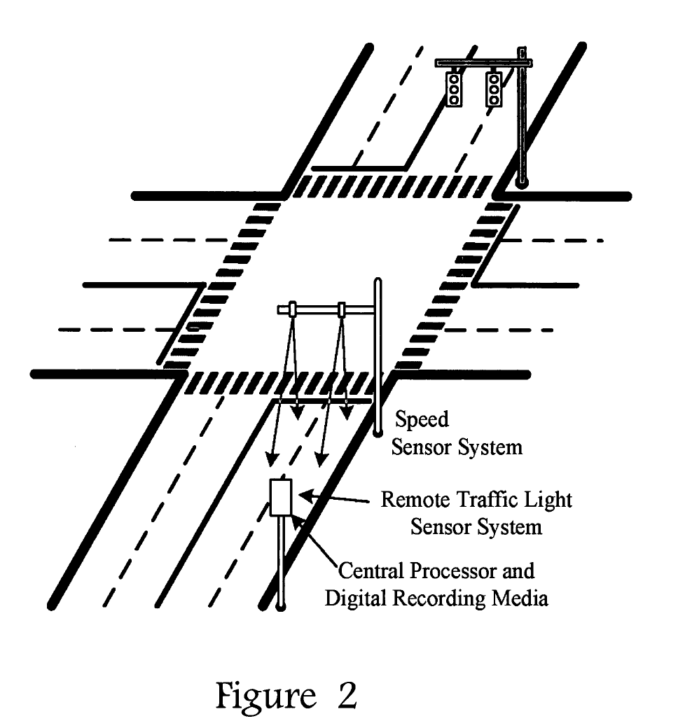

FIG. 2 illustrates the geometric layout of a possible implementation of a photo-enforcement system employing the remote traffic light sensor of the present invention. Special attention should be given to the design of the optical system and its field of view. The exact optical design will depend on the layout of a specific intersection. It is desirable, however, that the field of view for each detector is about 2 to 3 times the size of the light to be monitored in order to eliminate false readings due to possible movement of the traffic signal enclosure.

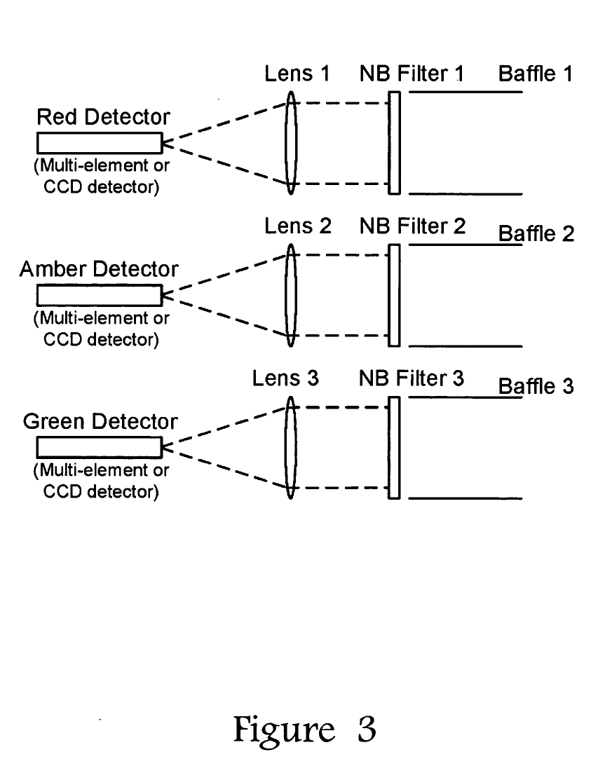

An optical arrangement of a remote traffic light status sensor is shown in FIG. 3. The sensor comprises three lenses, three detectors, and three narrow band transmission filters. Each combination of detector, lens, and narrowband filter is dedicated to detect a single light state (red, amber, or green), which is dictated by the pass band wavelength of the filter. A baffle surrounding the lens or filter helps prevent spurious, distracting light from interfering with operation of the detector. The detector can be a single element photo detector, a multi element photo detector, or a monochrome/color CCD detector, as described below.

Optical radiation from the traffic light is filtered by bandpass filters and is incident on only one of the lenses (since only one filter will allow light of a desired wavelength to pass through). The pass bands of the individual filters depend on the type of lights used in the signal device. In the case of LED (Light Emitting Diode) lights, a narrower bandpass filter can be used since the emission wavelength of LED lights is narrower as compared with traditional incandescent lights. The lens focuses the collected light onto a detector corresponding to a predetermined detected color and an electrical output is generated. The traffic signal status is determined according to which detector generates the output and the traffic signal status is communicated to one or more interfaced controllers.

Data collected and processed by the remote sensor system can generate useful information concerning the traffic signal under surveillance. Inspection of the traffic signal timing sequence can reveal whether the traffic signal is operated according to the rules and regulations of the local government.

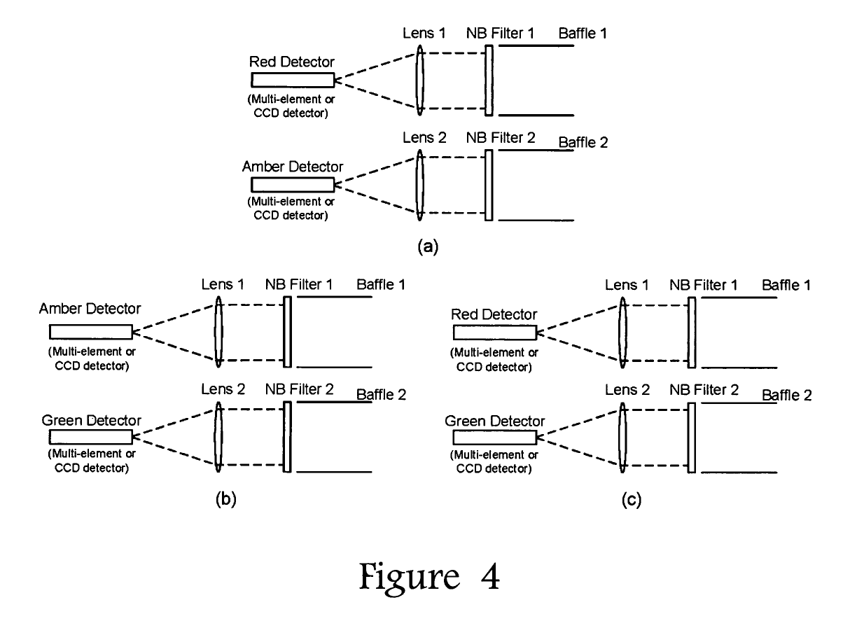

In some embodiments, it is not necessary to employ three detectors. Other embodiments of the remote traffic light status sensor are shown in FIG. 4. For example, instead of using sets of three components, the systems shown employ only two sets of detectors. Part (a) shows use of only a red detector and an amber detector. It is assumed that absence of an output from both the red and amber detectors signifies that the third, green light is on. Part (b) shows use of only an amber detector and a green detector. It is assumed that absence of an output from both the amber and green detectors signifies that the third, red light is on. Part (c) shows use of only a red detector and a green detector. It is assumed that absence of an output from both the red and green detectors signifies that the third, amber light is on. Any one of such arrangements can be used as a cost-saving measure while maintaining an accurate, logical output.

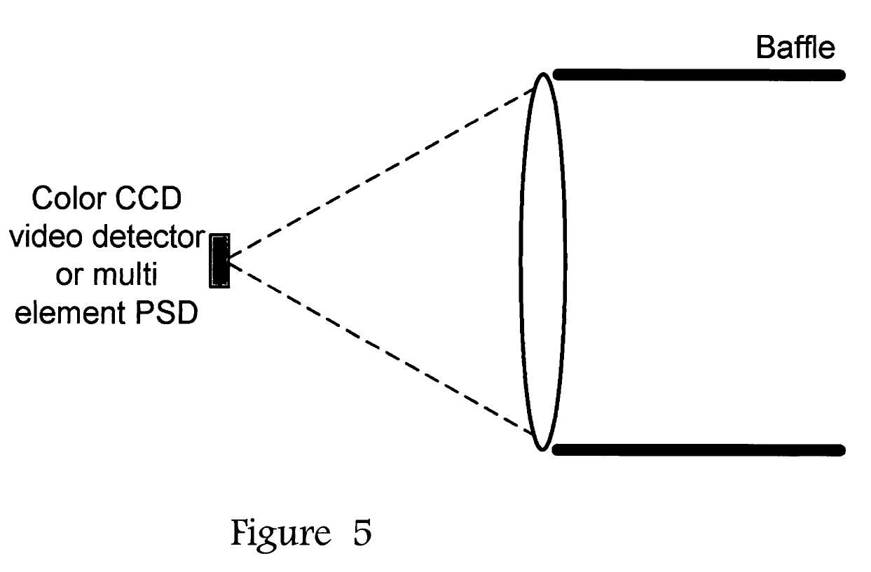

Instead of using individual detectors, lenses, and filters to determine the state of the traffic light, the disclosed system can be constructed using a single lens and a color video CCD detector or a multi element position sensitive detector (PSD). This system is schematically shown in FIG. 5. Of course, the robustness of the sensor system is improved by using multi-element photo detectors or monochrome CCD detectors in place of a single element photo detector. Furthermore, color CCD detectors eliminate the need for a bandpass filter in front of every detector.

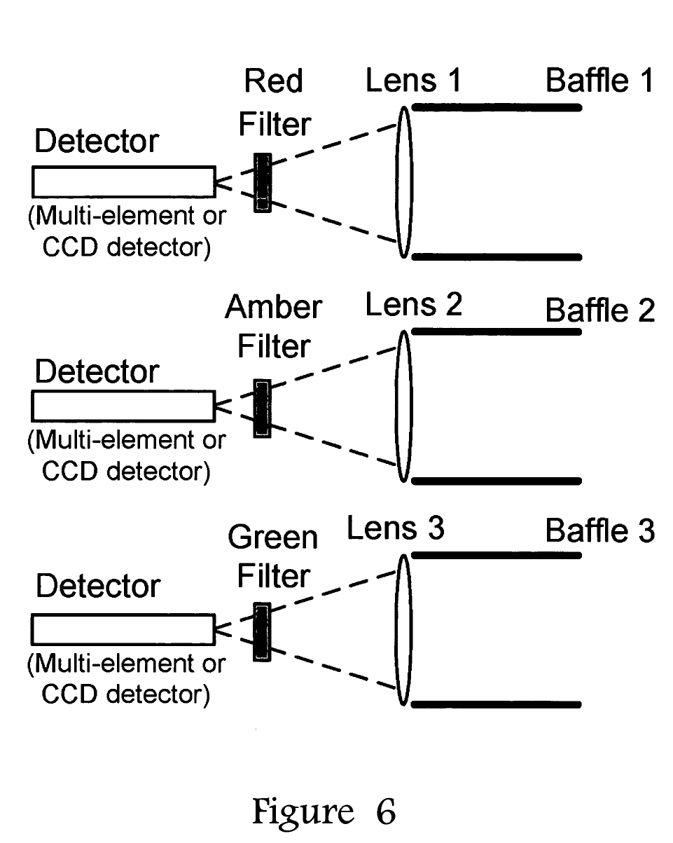

In an alternate embodiment, the narrowband filter is placed between the lens and the detector resulting in a smaller filter size. This option, shown in FIG. 6, reduces the construction cost since, in general, the cost of a narrowband filter is proportional to its size.

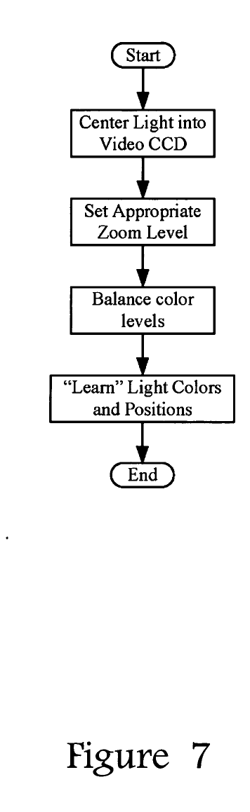

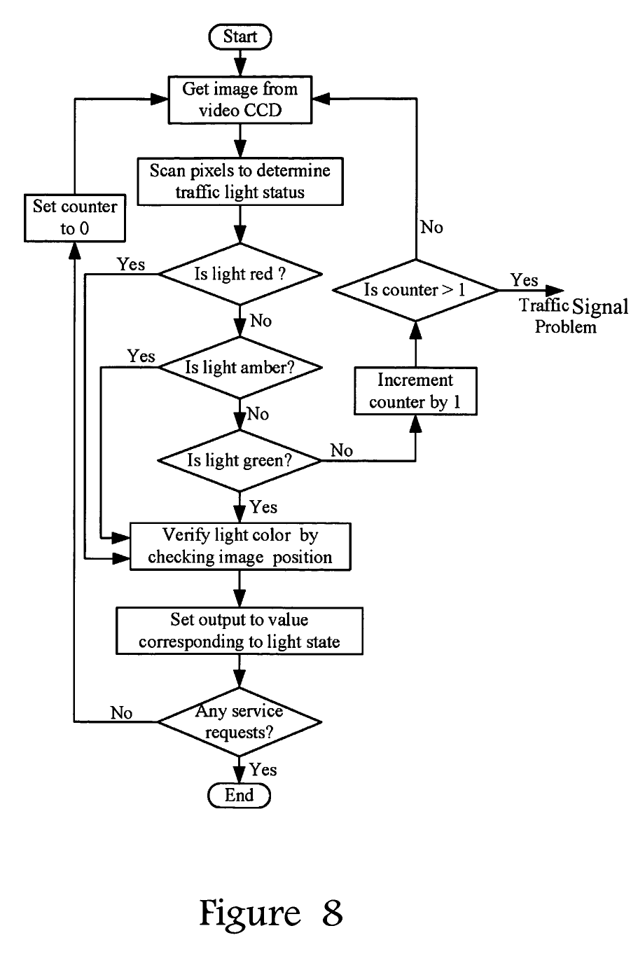

Detection of the light status using the setup shown in FIG. 5 can be accomplished using a series of algorithms. In the algorithms the state of the individual pixels in the two dimensional detectors is considered. The algorithms used for initialization and operation of the remote traffic light status sensor system are illustrated in FIGS. 7 and 8.

As shown in FIG. 7, upon installation of the remote traffic light sensor, a routine is executed in order to initialize and calibrate the sensor system. A more precise explanation of the processes during the various steps involved is listed in table 1.

TABLE 1
Installation/Calibration Algorithm of the remote traffic light status sensor system

| | |
|---|---|
| Step 1 | Start the “Installation/Calibration” algorithm. |
| Step 2 | Center the image of the whole traffic light onto the video CCD. This is |
| | accomplished by aligning a three-circle reference to the recorded image. |
| Step 3 | Set appropriate zoom so that the traffic light is at the center of the CCD and its |
| | height occupies about half the size of the CCD. |
| Step 4 | Balance the color levels and brightness intensity for optimum results. |
| Step 5 | Learn the light colors and positions. This is accomplished by recording the |
| | color corresponding to each state and saving it as reference. The position of |
| | the three-circle reference is also recorded for use during normal operation of |
| | the sensor system. |
| Step 6 | End the “Installation/Calibration” algorithm. |

The algorithm shown in FIG. 8 and explained in Table 2 illustrates the normal operation of the sensor and how the traffic light status is detected.

TABLE 2
Operational algorithm of the remote traffic light status sensor system

| | |
|---|---|
| Step 1 | Start the “Operational” algorithm. |
| Step 2 | Get a digital image file of the traffic signal from the video CCD. |
| Step 3 | Scan the pixels corresponding to the image to determine the status of the |
| | traffic signal. |
| Step 4 | Check whether the red light is illuminated. If the light is red then proceed to |
| | verify the red-light status by checking the position of the light relative to the |
| | whole image. If the light is not red then proceed to next step. |
| Step 5 | Check whether the amber light is illuminated. If the light is amber then |
| | proceed to verify the amber-light status by checking the position of the light |
| | relative to the whole image. If the light is not amber then proceed to next step. |
| Step 6 | Check whether the green light is illuminated. If the light is green then |
| | proceed to verify the green-light status by checking the position of the light |
| | relative to the whole image. |
| | If the light is not green then increase a counter by 1 (i.e. raise a flag since |
| | the traffic light is not in any of the possible states and it may have |
| | malfunctioned). |
| | If the counter is greater than 1 then issue a “Traffic Light Service |
| | Request”. If not then start the algorithm again by getting an image from the |
| | video CCD. |
| Step 7 | Set output to a state corresponding to the traffic signal state. |
| Step 8 | Check whether any service request has been issued. If yes then end, else |
| | proceed to next stage. |
| Step 9 | Clear the contents of the counter. |
| Step 10 | Start the algorithm again by getting a digital image from the video CCD. |

The system is specifically useful for Red-Light Camera violation detection. In operation, the speed of passing vehicles is estimated using a traffic sensor system and the status of the traffic light is detected by the remote traffic light sensor system described herein. In a preferred embodiment, the remote traffic light sensor system is located in the same housing as the recording media, which may be a digital camera or other appropriate recording device. The remote traffic light status system provides input to a controller/CPU in the violation detection system about the traffic signal status. This input together with speed estimated provided by the traffic sensor system is used to make a decision whether a violation is about to occur. If a violation is likely, the controller/CPU initiates a series of recordings for documenting the violation.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A traffic light sensor, comprising:
a light detector;
at least one lens; and
a filter selected to allow a substantially single color light to pass therethrough wherein said light detector provides an output upon receiving said single color light.

2. The traffic light sensor according to claim 1, further comprising a baffle.

3. The traffic light sensor according to claim 1, said filter further comprising a narrowband filter.

4. The traffic light sensor according to claim 3, wherein said substantially single color light is selected from the group consisting of:
amber;
red; and
green . . .

5. The traffic light sensor according to claim 1, wherein said filter is placed between said detector and said lens.

6. The traffic light sensor according to claim 1, wherein said lens is placed between said detector and said filter.

7. The traffic light sensor according to claim 1, wherein said detector is selected from the group consisting of:
single element photo detector;
multi-element photo detector;
monochrome charge-coupled device video detector; and
color charge-coupled device video detector.

8. A traffic light sensor, comprising:
a first light detector and a second light detector;
at least one lens for each of said first light detector and said second light detector;
a first filter associated with said first light detector selected to allow a first substantially single color light to pass therethrough; and
a second filter associated with said second light detector selected to allow a second substantially single color light to pass therethrough, said second substantially single color light being different than said first substantially single color light
wherein said first and second light detectors provide an output upon receiving said substantially single color light.

9. The traffic light sensor according to claim 8, further comprising a first baffle associated with said first detector and a second baffle associated with said second detector.

10. The traffic light sensor according to claim 8, said first and second filters further comprising narrowband filters.

11. The traffic light sensor according to claim 10, wherein said substantially single color light is selected from the group consisting of:
amber;
red; and
green.

12. The traffic light sensor according to claim 8, wherein at least one of said first and second filter is placed between its associated detector and lens.

13. The traffic light sensor according to claim 8, wherein said at least one lens for each of said first and second detector is placed between its associated detector and filter.

14. The traffic light sensor according to claim 8, wherein the output from said first and second detector is directed to a control device to determine violations of a traffic signal.

15. The traffic light sensor according to claim 14, wherein the first and second filters are selected from the group consisting of:
a red light filter and a green light filter;
a red light filter and an amber light filter; and
an amber light filter and a green light filter.

16. The traffic light sensor according to claim 8, wherein said first and second detector is selected from the group consisting of:
single element photo detector;
multi-element photo detector;
monochrome charge-coupled device video detector; and
color charge-coupled device video detector.

17. The traffic light sensor according to claim 8, further comprising:
a third light detector;
at least one lens for said third light detector; and
a third filter associated with said third light detector selected to allow a third substantially single color light to pass therethrough, said third substantially single color light being different than said first and second substantially single color light
wherein said first, second, and third light detectors provide an output upon receiving said substantially single color light.

18. The traffic light sensor according to claim 17, wherein said third detector is selected from the group consisting of:
single element photo detector;
multi-element photo detector;
monochrome charge-coupled device video detector; and
color charge-coupled device video detector.

19. A remote traffic light sensor, comprising:
at least one lens;
a position sensitive detector; and
a three-circle reference
wherein said three-circle reference is aligned to permit light from each of three traffic signal lights to pass through one of said circles before said light is detected by said position sensitive detector.

20. The remote traffic light sensor according to claim 19, wherein said position sensitive detector provides an output indicative of which light of said traffic signal is illuminated based upon the location of light in said three-circle reference.
